(19) United States
(12) Patent Application Publication
(10) Pub. No.: US 2005/0275974 A1
(43) Pub. Date: Dec. 15, 2005

(54) Magnetic reproducing head and magnetic disk apparatus

(75) Inventor: Masayuki Takagishi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/127,132

(22) Filed: May 12, 2005

(30) Foreign Application Priority Data
May 31, 2004 (JP) 2004-161419

(51) Int. Cl. G11B 5/127

(52) U.S. Cl. 360/313

(57) ABSTRACT

A magnetic reproducing head which reproduces information recorded on a recording medium by a vertical magnetic recording method, comprising a magnetoresistance effect element including a free layer whose resistance varies in response to a variation in external magnetization, and a hard bias layer which forms the free layer into a single magnetic domain, wherein (Mrt1/Mrt2)≧3.0 is set when a product of residual magnetization of the hard bias layer and thickness thereof is set to Mrt1 and strength of medium magnetization of the recording medium is set to Mrt2.

### CROSS-REFERENCE TO RELATED APPLICATIONS

This application is based upon and claims the benefit of priority from prior Japanese Patent Application No. 2004-161419, filed May 31, 2004, the entire contents of which are incorporated herein by reference.

### BACKGROUND OF THE INVENTION

1. Field of the Invention

This invention relates to a magnetic disk apparatus such as a hard disk drive (HDD) and a magnetic reproducing head used in the apparatus. Particularly, this invention relates to the technique for reading out information recorded on a magnetic recording medium by a vertical magnetic recording method.

2. Description of the Related Art

In recent years, the size of magnetic recording apparatuses, including hard disk units, has been rapidly getting smaller and so the recording density has been getting higher. This trend is expected to become stronger in the future. To achieve high recording density, it is necessary not only to increase the recording track density by narrowing the recording tracks but also to increase the recoding density (or line recording density) in which recording is done. Accordingly, much attention is paid to the vertical magnetic recording method instead of the conventional in-plane magnetic recording method (for example, refer to Jpn. Pat. Appln. KOKAI Publication No. 2002-197620).

In the in-plane magnetic recording method, magnetization is produced in a direction parallel to the plane of the recording medium. In contrast, in the vertical recording method, magnetization is produced in a direction perpendicular to the plane of the recording medium. Therefore, recording magnetization is difficult to be reduced according to the vertical recording method and it is expected that the vertical recording method can greatly contribute to enhancement of the recording density of the magnetic recording apparatus. Further, in the vertical magnetic recording method, since the strength of a magnetic field flowing into the reproducing head surrounded by a shield is generally higher than that in the in-plane medium, a reproducing output becomes higher. This is also an advantage of the vertical magnetic recording method.

In the in-plane recording method, magnetic flux flows out only from the magnetization transition region of the recording medium. In contrast, in the vertical recording method, magnetic flux flows out from the entire portion of the DC region of the recording medium. Therefore, in the vertical recording method, an amount of magnetic flux flowing from the medium into the reproducing head is larger than that in the in-plane recording method. This brings a merit that a high reproducing output can be attained, but it is understood that this also brings a demerit.

For example, it is assumed that an MR effect (magnetoresistance effect) type reproducing head is used. The MR effect type reproducing head has a free layer, a hard bias layer which controls magnetization of the free layer, and a shield layer which surrounds the above two layers. The free layer moves along the surface of the medium according to the relative movement between the magnetic reproducing head and the recording medium. In the vertical magnetic recording method, when the free layer is located in a portion which extends over data tracks recorded in the medium, a high level of noise is output in some cases. One of the causes is that the amount of magnetic flux flowing from the recording medium into the reproducing head is large.

When noise is generated in a state in which the free layer is positioned on the user data track, the reproduction waveform becomes unstable and a readout error or the like occurs. To make matters worse, if noise becomes larger in a state in which the free layer is positioned in a servo area of the medium, it becomes impossible to perform the servo positioning process in some cases. In this case, since the magnetic reproducing head cannot precisely trace the track, the problem becomes more serious.

### BRIEF SUMMARY OF THE INVENTION

According to an aspect of the present invention, there is provided a magnetic reproducing head which reproduces information recorded on a recording medium by a vertical magnetic recording method, comprising a magnetoresistance effect element including a free layer whose resistance varies in response to a variation in external magnetization, and a hard bias layer which forms the free layer into a single magnetic domain, wherein (Mrt1/Mrt2)≧3.0 is set when a product of residual magnetization of the hard bias layer and thickness thereof is set to Mrt1 and strength of medium magnetization of the recording medium is set to Mrt2.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an air bearing surface (ABS) of a magnetic reproducing head according to one embodiment of this invention.

FIG. 2 is a view showing the positional relation between the tracks of the magnetic disk medium and the magnetoresistance effect element of FIG. 1.

FIG. 3 is a schematic diagram showing the positional relation between the magnetic reproducing head and burst signals in the servo area of the disk medium.

FIG. 4 is a view showing a state in which magnetic domains are formed in the free layer 1.

FIG. 5 is a view for illustrating the effect of a single magnetic domain formed by providing the hard bias layers 9, 10.

FIG. 6 is a cross sectional view taken along the one-dot-dash line VII-VII′ of FIG. 2.

FIG. 7 is a graph indicating the result of the measured relation between the Mrt ratio and the noise level.

FIG. 8 is a graph indicating the result of measurements of the critical point (least necessary Mrt ratio) shown in FIG. 7 while changing the reproduction gap length GL.

FIG. 9 is a graph showing the necessary Mrt ratio (least Mrt ratio) derived from dPW50 on the assumption that UBD (the ratio of dPW50 to the bit length) is kept constant.

FIG. 10 is a perspective view of a hard disk unit in which the magnetic reproducing head shown in FIG. 1 can be installed.

FIG. 11 is an enlarged perspective view of the tip part extending from the actuator arm 155 of a magnetic reproducing head assembly 160 in the hard disk unit of FIG. 10, when looked at from the medium side.

### DETAILED DESCRIPTION OF THE INVENTION

FIG. 1 is a view showing an air bearing surface (ABS) of a magnetic reproducing head according to one embodiment of this invention. The magnetic reproducing head includes a magnetoresistance effect element, generally called an MR effect type element, and whose resistance varies according to variation in the external magnetic field. The magnetoresistance effect element has a free layer 1 which is a ferromagnetic layer. A spacer 2, pinning layer 3 and seed layer 4 are laminated in this order on the free layer 1. The free layer 1 is formed into a single magnetic domain by the presence of hard bias layers 9, 10. Shields 5, 6 are formed to surround the magnetoresistance effect element and hard bias layers 9, 10. Further, antiferrormagnetic layers 7, 8 are respectively laminated on and adjacent to the hard bias layers 9, 10.

In FIG. 1, the length indicated by a symbol GL indicates the reproducing gap length. Magnetization of the free layer 1 varies according to the magnetic flux (or magnetic field) from the medium, thus the resistance of the free layer 1 varies according to the variation amount of the magnetic flux. By removing this the resistance variation from the output, a variation in the magnetic flux of the medium is output as an electrical signal. In recent years, a GMR element based on this very principle has been provided.

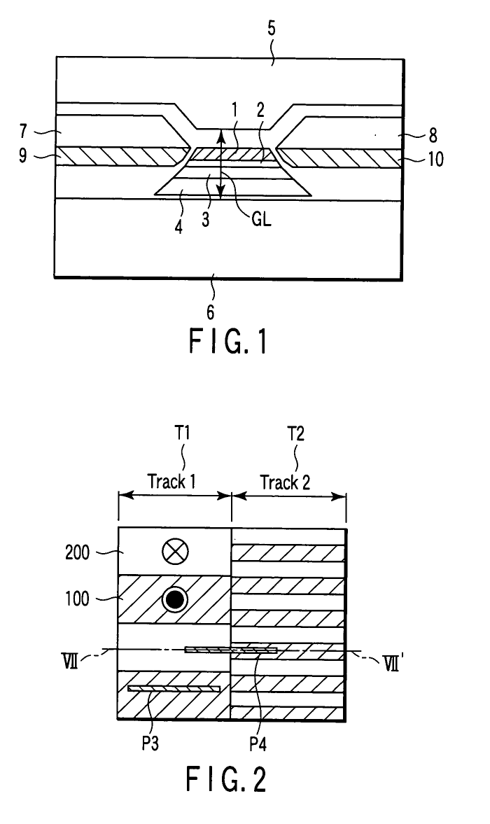

FIG. 2 is a view showing the positional relation between the tracks of the magnetic disk medium and the magnetoresistance effect element of FIG. 1. In FIG. 2, different data items are written on the different tracks (tracks T1, T2). Each data item is digital data of “0” or “1” corresponding to the direction of medium magnetization. In FIG. 2, the magnetization directions are respectively indicated by stripes indicated by symbols 100 and 200. It is assumed that the magnetization direction of the medium magnetization 100 is set from the rear side towards the front side of the drawing and the magnetization direction of the medium magnetization 200 is set from the front side towards the rear side of the drawing.

When the reproducing head of FIG. 1 moves on the magnetic disk, the free layer 1 also moves. At this time, noise levels are greatly different from each other in positions respectively indicated by P3 and P4 in FIG. 2. In the position P3, the free layer 1 is positioned on one track. In contrast, in the position P4, the free layer 1 is positioned to extend over different tracks. More specifically, in the position P4, the free layer 1 lies across the boundary between the tracks T1 and T2. In this state, there is a possibility that much noise occurs. One of the reasons for this is the large amount of magnetic flux flowing from the magnetic medium into the reproducing head in the vertical magnetic recording method.

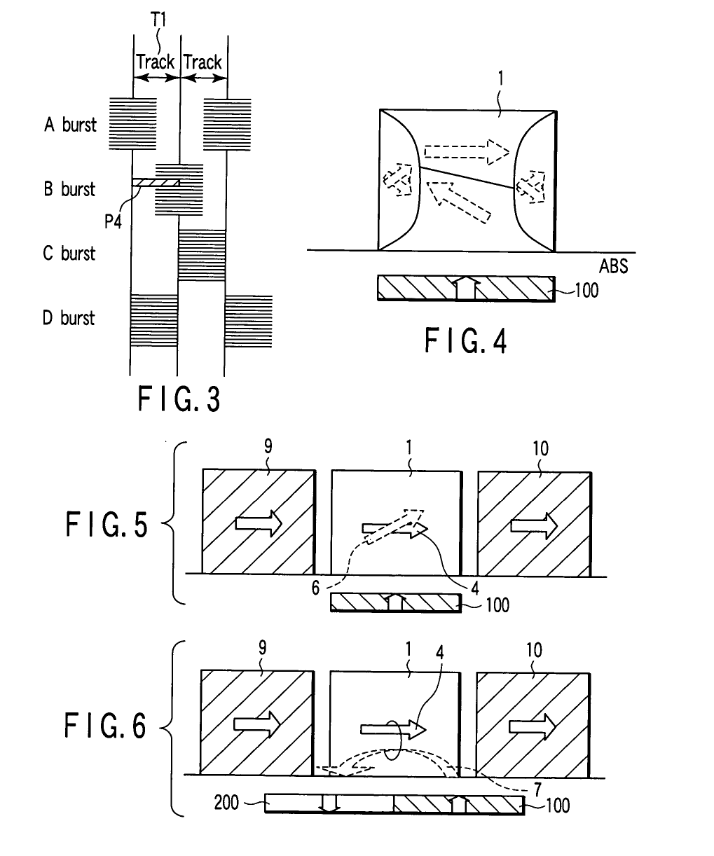

FIG. 3 is a schematic diagram showing the positional relation between the magnetic reproducing head and burst signals in the servo area of the disk medium. Generally, signals (burst patterns) used to control the position of the magnetic head are written in the disk medium. Four types of burst patterns are provided and respectively referred to as A burst, B burst, C burst and D burst.

In FIG. 3, the reproduction signal level of the D burst becomes the largest and the C burst signal is not detected while the magnetic reproducing head is tracing the track T1. At this time, the reproduction levels of the A burst signal and B burst signal are set to half the reproduction level of the D burst signal. It is possible to detect the relative position between the magnetic reproducing head and the track by obtaining the ratio of the reproduction level of the A burst signal to the reproduction level of the B burst signal. Based on the above principle, the process of causing the head to precisely trace the track can be performed at the seek time of the head.

In FIG. 3, for example, the same state as that shown in FIG. 2 is set in the position indicated by P4. That is, in the existing technique, when the head passes through the A burst and B burst, much noise tends to occur. This means that much noise occurs in the servo positioning operation, and therefore, it is necessary to take preventive measures.

FIG. 4 is a view showing a state in which magnetic domains are formed in the free layer 1. It is assumed that the hard bias layers 9, 10 of FIG. 1 are not provided. In this case, magnetization of the free layer 1 is set in various directions in the film and the free layer is divided into small regions with magnetization of the same direction. The block of magnetization in the same direction is called a magnetic domain. In this state, if a medium magnetization portion 100 comes directly below the air bearing surface (ABS), magnetic flux flows into the free layer 1 since the direction of the medium magnetization portion 100 is set in a vertical position. As a result, magnetization of the free layer 1 varies in a complex fashion. Due to the complex disturbance of magnetization, a problem of noise of a head reproduction output and hysteresis occurs. Therefore, the hard bias layers 9, 10 are provided to set the magnetic domains of the free layer 1 into one magnetic domain. This magnetic domain is called a single magnetic domain.

FIG. 5 is a view for illustrating the effect of a single magnetic domain formed by providing the hard bias layers 9, 10. The magnetic domains of the free layer 1 are set into one magnetic domain by providing the hard bias layers 9, 10 and a variation in the magnetization becomes extremely simple even when the medium magnetization portion 100 is directly below the free layer. Therefore, a problem of noise and hysteresis does not occur. However, even if the hard bias layers 9, 10 are provided, a problem of noise and hysteresis will occur in some cases in the vertical magnetic recording method. This is explained in detail with reference to FIG. 6.

FIG. 6 is a cross sectional view taken along the one-dot-dash line VII-VII′ of FIG. 2. As shown in FIG. 6, the free layer 1 is formed into a single magnetic domain by the presence of the hard bias layers 9, 10. The magnetization direction of the magnetic domain is indicated by an arrow 40. In this state, the magnetic flux from the medium magnetization portions 100, 200 lying directly below the free layer 1 passes through the lower portion (ABS side) of the free layer. As a result, in the positional relation of FIG. 6, magnetization which matches the magnetization 40 is induced due to the presence of the medium magnetization portions 100, 200 directly below the free layer 1. Therefore, if the medium magnetization is strong, the single magnetic domain structure of the free layer 1 cannot be maintained and much noise will be generated at this time.

The critical point of noise thus generated is determined by the ratio of the strength of hard bias to the strength of medium magnetization. The strength of hard bias is indicated by the product (Mrt) of the residual magnetization Mr of hard bias and the thickness t. Likewise, the strength of medium magnetization can also be expressed by Mrt. At this time, the value (Mrt of hard bias)/(Mrt of medium magnetization) is used and referred to as the Mrt ratio.

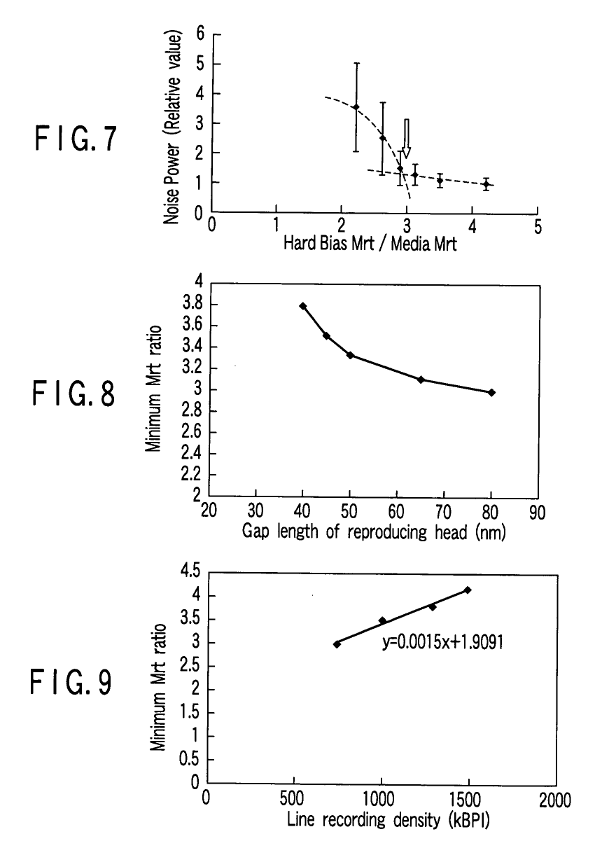

FIG. 7 is a graph indicating the result of the measured relation between the Mrt ratio and the noise level. In FIG. 7, the reproduction gap length GL is 80 nanometers, the reproduction width is 110 nanometers and the floating (or rising) amount is 15 nanometers. According to FIG. 7, it is understood that noise becomes abruptly larger when the Mrt ratio indicated on the abscissa becomes equal to or smaller than 3.0.

Generally, Mrt of the hard bias is set to a necessary minimum value required for forming the free layer into a single magnetic domain, and corresponds to a portion approximately equal to 2.1 on the abscissa of FIG. 7. This is because the free layer is more strongly magnetized and becomes more difficult to move and an output thereof becomes lower as the hard bias becomes stronger. On the other hand, in the present embodiment, the value of Mrt of the hard bias is set to as large as 3.0. That is, in the vertical magnetic recording method, the relation expressed by the following expression (1) is defined in the present embodiment in order to attain the stable operation in a region containing the servo region.
(Mrt of hard bias)/(Mrt of medium magnetization)≧3.0 (1)

More generally, when the product of the residual magnetization of the hard bias layer and the thickness thereof is set to Mrt1 and the strength of medium magnetization of the disk medium is set to Mrt2, the values are so set as to satisfy the relation expressed by the following expression (1′).
(Mrt1/Mrt2)≧3.0 (1′).

FIG. 8 is a graph indicating the result of measurements of the critical point (least necessary Mrt ratio) shown in FIG. 7 while changing the reproduction gap length GL. As shown in FIG. 8, the necessary Mrt ratio becomes larger as the gap length GL becomes smaller. This is because it is necessary to set a strong hard bias, since a variation in the medium magnetic flux near the ABS portion is smooth, although the magnetic flux from the hard bias layer tends to escape into the upper and lower shielding portions when the gap length GL becomes smaller.

It is necessary to enhance the resolution of the reproducing head in order to set the reproducing head to correspond to the high line recording density and the value of dPW50 indicates enhancement of the resolution in the vertical magnetic recording method. Enhancing the resolution indicates reducing the value of dPW50. In order to attain this, it is required to reduce the gap length and make small the floating amount. Since the magnetic flux which flows from the medium into the free layer increases if the floating amount is made small, it becomes necessary to increase the Mrt ratio. It is required to increase the Mrt ratio in order to stabilize the reproducing signal (particularly, a servo signal) and enhance the line recording density by reducing the gap length and making the floating amount small.

FIG. 9 is a graph showing the necessary Mrt ratio (least Mrt ratio) derived from dPW50 on the assumption that UBD (the ratio of dPW50 to the bit length) is kept constant. As is understood from FIG. 9, the necessary Mrt ratio linearly increases with an increase in the line recording density. The relation can be expressed by the following expression (2).
Necessary Mrt ratio>1.5×line recording density (MBPI)+1.9 (2)

In the above expression, (MBPI) is a value BPI×10⁶.

When the line recording density is equal to or lower than 500 kBPI, the necessary Mrt ratio is set to a value corresponding to the hard bias strength required for forming the free layer 1 into the single magnetic domain. Therefore, the relation expressed by the expression (2) can be more preferably applied particularly to a portion in which BPI is large (BPI>0.7 MBPI). That is, it is possible to attain the stable operation of the hard disk unit with the line recording density of 700 kBPI or more by satisfying the relation expressed by the expression (2).

The relation expressed by the expression (2) can be more generally expressed by the following expression when the product of the residual magnetization of the hard bias layer and the thickness thereof is set to Mrt1, the strength of medium magnetization of the disk medium is set to Mrt2 and a value of the line recording density of the disk medium expressed by using MBPI as a unit is set to Q.
(Mrt1 /Mrt2)≧1.5×Q+1.9 (2′)

As described above, in the present embodiment, in the magnetic reproducing head which reproduces information recorded on the disk medium by the vertical magnetic recording method, the magnetoresistance effect element having the free layer 1 whose resistance varies in response to a variation in the external magnetization, and the hard bias layers 9, 10 which form the free layer 1 into the single magnetic domain are provided. When the product of the residual magnetization of the hard bias layers 9, 10 and the thickness thereof is set to Mrt1 and the strength of the medium magnetization of the disk medium is set to Mrt2, the relation of (Mrt1/Mrt2)≧3.0 is satisfied. Particularly, in the present embodiment, when the line recording density of the disk medium is set to Q, the relation of (Mrt1/Mrt2)≧1.5×Q+1.9 is satisfied.

The single magnetic domain of the free layer 1 can be maintained by setting the above relations even when magnetization flows from the disk medium into the magnetic reproducing head. Thus, even if the vertical recording medium is used, occurrence of a high level of noise which will occur at the reproduction time, particularly when the servo positioning operation is performed, can be prevented. Therefore, it becomes possible to provide a highly reliable magnetic reproducing head which is optimized for the vertical medium characteristic.

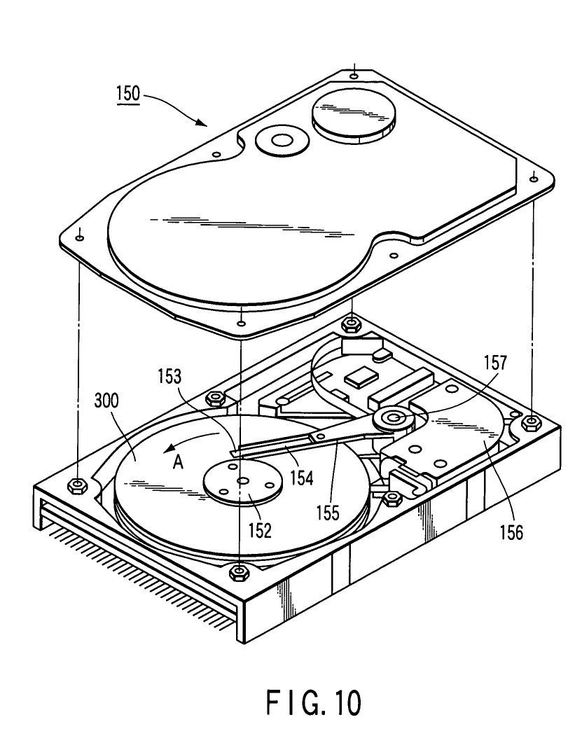

FIG. 10 is a perspective view of a hard disk unit in which the magnetic reproducing head shown in FIG. 1 can be installed. A magnetic reproducing head related to the present invention can be installed in a magnetic disk apparatus which reads digital data magnetically recorded on a magnetic recording medium. A typical magnetic recording medium is a platter built in a hard disk drive. In addition, a magnetic reproducing head related to the present invention can be installed in a magnetic recording and reproducing apparatus which also has the function of writing digital data onto a magnetic recording medium.

In a hard disk unit 150 of FIG. 10, a rotary actuator is used to move a magnetic head. In FIG. 10, a recording disk medium 300 is installed on a spindle 152. The disk medium 300 is rotated in the direction shown by arrow A by a motor (not shown) which responds to a control signal from a driving unit control section (not shown). More than one disk medium 300 may be provided. This type of apparatus is known as the multi-platter type.

A head slider 153, which is provided at the tip of a thin-film suspension 154, stores information onto the disk medium 300 or reproduces the information recorded on the disk medium 300. The head slider 153 has the magnetic head of FIG. 1 provided near its tip.

The rotation of the disk medium 300 causes the air bearing surface (ABS) of the head slider 153 to float a specific distance above the surface of the disk medium 300. The present invention is applicable to a so-called contact running unit in which the slider is in contact with the disk medium 300.

The suspension 154 is connected to one end of an actuator arm 155 which includes a bobbin section (not shown) that holds a driving coil (not shown). A voice coil motor 156, a type of linear motor, is provided to the other end of the actuator arm 155. The voice coil motor 156 is composed of a driving coil (not shown) wound around the bobbin section of the actuator arm 155 and a magnetic circuit including a permanent magnet and a facing yoke which are provided in such a manner that the magnet and yoke face each other with the coil sandwiched between them.

The actuator arm 155 is held by ball bearings (not shown) provided in the upper and lower parts of the spindle 157 in such a manner that the arm 155 can be rotated freely by the voice coil motor 156.

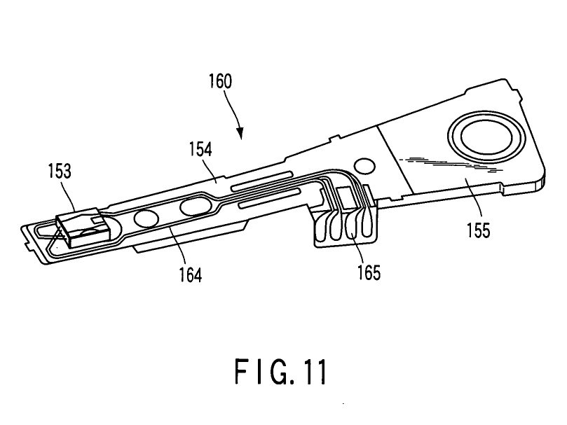

FIG. 11 is an enlarged perspective view of the tip part extending from the actuator arm 155 of a magnetic reproducing head assembly 160 in the hard disk unit of FIG. 10, when looked at from the medium side. In FIG. 11, the magnetic reproducing head assembly 160 has the actuator arm 155. A suspension 154 is connected to one end of the actuator arm 155. At the tip of the suspension 154, there is provided a head slider 153 including the magnetic reproducing head of FIG. 1. The suspension 154 has leads 164 for writing and reading a signal. The leads 164 are connected electrically to the individual electrodes of the magnetic head built in the head slider 153. The leads 164 are also connected to electrode pads 165.

As shown in FIGS. 10 and 11, the reliability of the hard disk unit can be further enhanced by using the magnetic reproducing head of FIG. 1.

This invention is not limited to the above embodiment. For example, in the above embodiment, a case wherein the CIP-GMR element is used as an example is explained, but this is not limitative. This invention can be applied to any type of magnetic reproducing element if the magnetic reproducing element which has a free layer and causes the free layer to be stabilized by use of hard bias is used. As this type of element, a tunnel magnetoresistance element (TMR element) or CPP (Current Perpendicular-to-the-Plane)-GMR element is provided, for example.

Further, this invention is not limited to the above embodiment as it is and this invention can be embodied by modifying the constituents without departing from the technical scope at the stage of the embodiment. In addition, various inventions can be made by adequately combining a plurality of constituents disclosed in the above embodiment. For example, some constituents can be eliminated from all of the constituents disclosed in the above embodiment.

1. A magnetic reproducing head which reproduces information recorded on a recording medium by a vertical magnetic recording method, comprising:
a magnetoresistance effect element including a free layer whose resistance varies in response to a variation in external magnetization, and
a hard bias layer which forms the free layer into a single magnetic domain,
wherein (Mrt1/Mrt2)≧3.0 is set when a product of residual magnetization of the hard bias layer and thickness thereof is set to Mrt1 and strength of medium magnetization of the recording medium is set to Mrt2.

2. The magnetic reproducing head according to claim 1, wherein (Mrt1/Mrt2)≧1.5×Q+1.9 is set when a value of line recording density of the recording medium expressed by using MBPI (Mega bit per inch) as a unit is set to Q.

3. The magnetic reproducing head according to claim 2, wherein Mrt1 is increased with an increase in Q.

4. A magnetic disk apparatus comprising the magnetic reproducing head according to claim 1, wherein magnetic information recorded on a magnetic recording medium is reproduced by using the magnetic reproducing head.

5. A magnetic disk apparatus comprising the magnetic reproducing head according to claim 2, wherein magnetic information recorded on a magnetic recording medium is reproduced by using the magnetic reproducing head.

6. A magnetic disk apparatus comprising the magnetic reproducing head according to claim 3, wherein magnetic information recorded on a magnetic recording medium is reproduced by using the magnetic reproducing head.
